(19) United States
(12) Patent Application Publication
(10) Pub. No.: US 2026/0307551 A1
(43) Pub. Date: Oct. 8, 2026

(54) Dust Protection Device for Automobile Seat Rails

(71) Applicant: Zhifeng YAO, Jiangmen (CN)

(72) Inventor: Zhifeng YAO, Jiangmen (CN)

(21) Appl. No.: 19/483,590

(22) PCT Filed: May 8, 2024
(86) PCT No.: PCT/CN2024/091564

§ 371 Date: Nov. 11, 2025

(30) Foreign Application Priority Data
May 11, 2023 (CN) 202310533798.5

(51) Int. Cl. B60N 2/07

(52) U.S. Cl. CPC B60N 2/0725

(57) ABSTRACT

A dust-proof device for automobile seat rails is provided. The dust-proof device includes: at least one bracket structure connectable to a seat slide groove, at least one elastic return structure, an end cap, at least one slider structure connected to the end cap, and cover plate structures which match the top profile of the seat slide groove. Each cover plate structure is movably connected to the slider structure in an embedded manner, and can slide relative to the slider structure in a longitudinal direction. The bracket structure is in embedded connection with a slider of the slider structure, and can make relative linear movement in the longitudinal direction. A rear end of the slider is fixedly connected to the end cap, and the slider returns by means of the elastic return structure. Two fixed fulcrums of the elastic return structure are respectively fixedly connected to one relatively fixed fulcrum and one relatively movable fulcrum. The end cap has a concave cavity structure which matches an end of the seat slide groove.

### TECHNICAL FIELD

The present application relates to the technical field of automobile seat rails and, in particular, to a dust-proof device for automobile seat rails.

### DESCRIPTION OF RELATED ART

With the improvement of living standards, automobiles are becoming more and more popular and have emerged as the main means of transportation for people to travel. Consequently, requirements for interior hygiene and riding comfort are getting higher and higher. Even though every corner inside an automobile is decorated without leaving any dead ends, the rails of automobile seats are often overlooked. In particular, rail grooves accommodate electric seat moving components and need to be lubricated. Moreover, because the seats need to be moved and adjusted frequently, a certain space must be reserved and cannot be covered. In addition, passengers often place their feet in this area when riding. Therefore, this area has become a place to hide dirt in the automobile. For this reason, many devices are invented in order to overcome this defect. The following invention documents disclose similar technologies for solving the foregoing related problems, but none of them completely solves the related issues.
Reference 1: A conventional technical solution, entitled “Vehicle Seat Rail Protector Assembly”, discloses the following: An end cap is disposed at the end of a specially manufactured automobile seat rail; the travel stroke of the end cap is equal to that of the seat; the end cap returns its original position by means of a pivot pin and a spring sleeved on the pivot pin. However, this device only achieves partial dust-proof protection for the end of the seat rail and cannot provide protection over a wider area of the seat rail. Moreover, the device has to be used together with a specific prefabricated seat rail; however, the device is not adapted to existing, universally used automobile seat rails on the market. When the ends of a rail member 24 and a rail member 28 under each seat are dislocated after movement, a rail area will be exposed and cannot be protected by the cover. Therefore, the function of this device is limited to protecting the ends of the rail members. The device is not compact in structure, has a large size, and may easily cause potential safety hazards to the use of the automobile seat.
Reference 2: A technical solution, entitled “Guide Rail Assembly”, discloses the following: Screen components, similar to two spring tape measures, are fixedly mounted on the front and rear ends of an automobile seat slide. The tape strips of the front and rear spring tape measures are connected by means of a moving part and fixed to the seat, and the tape strips are embedded in the two sides of the guide rail. When the seat moves, the front and rear tape strips stretch out and coil up to protect the rail. Although this technical solution offers a certain dust-proof protection effect, the screen component arranged in front of the rail is equivalent to two tape measures, which has a large size and occupies foot space. A protective sheet must be embedded in a specific prefabricated rail, and the rigidity of the protective sheet is too low to withstand large pressure, such as the gravity of a human stepping thereon. In addition, the protection range of the protective sheet is limited to the rail. However, when the technical solution is applied to the automobile seats currently available on the market, after the end of the rail connected to the seat moves, the end will go beyond the fixed rail end, and the use of this device will limit the sliding stroke of the seat. A similar structure to this is another technical solution, entitled “Device for Blocking Foreign Objects in Vehicle Seat Rail and Method for Assembling Same”. These two conventional technologies are only applicable to specific prefabricated automobile seat rails, which have the defect of short sliding strokes.
Reference 3: A technical solution, entitled “Dust-Proof Structure for Automobile Seat Rail and Use Method Thereof”, also discloses a dust-proof device for automobile seat rails similar to that of Reference 2, and the structure of the dust-proof device is also analogous to the solution of a scroll spring tape measure-type shielding belt being arranged in each of grooves at two ends of a fixed rail of an automobile seat. Shell structures provided with the shielding belt are relatively large in size and are fixed in the grooves at two ends of the rail, which greatly shortens the moving stroke of the automobile seat rail. This structural design is also only applicable to specially prefabricated seat rails and is not suitable for the known automobile seat rails available on the market.

### BRIEF SUMMARY OF THE INVENTION

### Technical Problem

Although numerous inventors have endeavored to overcome the defect of poor dust-proof effect in automobile seat slide rails, various drawbacks still exist. In particular, a wide variety of automobile seat slide rails of different specifications are available in the current market. Therefore, it is desired for a product that features low cost, simple and safe structure, and compatibility with various types of automobile seat rails of different specifications available on the current market, so as to replace products in the references and overcome the drawbacks of products in the references.

### Technical Solutions

The objective of the present application is to overcome the defects described above and provide an automobile seat rail dust-proof device featuring low cost, simple structure, convenient installation, high versatility, long service life, excellent dust-proof effect and compact structure. To achieve the above objective, the technical solution adopted in the present application is a dust-proof device for automobile seat rails. The dust-proof device includes: at least one bracket structure connectable to a seat slide groove, at least one elastic return structure, an end cap, at least one slider structure connected to the end cap, and a plurality of cover plate structures which match the top profile of the seat slide groove. The bracket structure at least includes a clamping strip fixable to a sidewall of the seat slide groove; the slider structure at least includes a slider. At least one transverse end of a cover plate of each cover plate structure is movably connected to a sidewall of the slider structure in an embedded manner, and can slide relative to the slider structure in a longitudinal direction. The clamping strip of the bracket structure is in embedded connection with a slider of the slider structure, and can make relative linear movement in the longitudinal direction. A rear end of the slider is fixedly connected to a sidewall of the end cap; the slider returns by means of the elastic return structure after movement. Two fixed fulcrums of the elastic return structure are respectively fixedly connected to one relatively fixed fulcrum and one relatively movable fulcrum. The end cap has a concave cavity structure which matches an end of the seat slide groove.

At least one longitudinally arc-shaped groove for guiding the cover plates to slide in is arranged on a sidewall of the concave cavity of the end cap.

The clamping strip is a strip-shaped body. A buckle that can be fastened to a side of the seat slide groove is provided at upper and/or lower edges of the inner side of the clamping strip and is fixed to the side of the seat slide groove. A strip-shaped groove or strip-shaped protruding rib that matches the strip-shaped slider is provided on an outer sidewall of the strip-shaped body.

The clamping strip is configured as a plurality of C-shaped buckles that can be directly fitted on the side of the seat slide groove. A strip-shaped groove or strip-shaped protruding rib which matches the strip-shaped slider is provided on an outer or inner sidewall of each C-shaped buckle.

The clamping strip is a clamping sleeve which can be fixed to the groove bottom of the seat slide groove by means of a screw and is matched with the strip-shaped slider; the strip-shaped slider is embedded in a gap of the clamping sleeve and can move linearly along the groove bottom of the seat slide groove in the longitudinal direction in the gap of the clamping sleeve.

The slider is a strip-shaped column. A strip-shaped groove or strip-shaped protruding rib which matches the strip-shaped protruding rib or strip-shaped groove on a sidewall of the bracket is provided on an inner or outer sidewall of the slider.

A convex guide strip or concave guide groove which is arranged in the longitudinal direction is provided on at least one outer sidewall of the slider, and the convex guide strip or concave guide groove is matched with a concave clamping groove or convex clamping strip arranged on a side edge of each cover plate.

The cover plates are sheet-shaped. At least one convex clamping strip or concave clamping groove which is arranged in the longitudinal direction is provided at least one of two ends of the cross section of each cover plate, and the convex clamping strip or concave clamping groove is matched with the concave guide groove or convex guide strip arranged on the sidewall of the slider of the slider device.

Each cover plate structure further includes at least one return spring, which is arranged between the cover plate and the slider or between the cover plate and the bracket structure; the spring arranged between the cover plate and the slider or between the cover plate and the bracket structure provides a rebound pulling force for the cover plate after movement.

The elastic return structure is arranged between an end of the bracket and an end of the slider, and two fixed fulcrums of the elastic return structure are respectively fixedly connected to the bracket and the slider so as to provide return power for the slider after movement.

The elastic return structure is arranged between sliders at the front and rear ends of an automobile seat, and two fixed fulcrums of the elastic return structure are respectively fixedly connected to front ends of the two sliders, so as to provide return power for the sliders after movement.

The cover plates and the end cap are integrated into one component.

The bracket and the slider are integrated into one component.

The slider structure and the end cap are integrated into one shell structure, and two end faces of an end cap shell are connected to a rear end face of the slider of the slider structure. At least one sliding shaft is arranged at a bottom side end face of the end cap shell; the sliding shaft is a strip-shaped sheet, and the cross section of the sliding shaft is rectangular, “T”-shaped or “L”-shaped.

At least one convex guide strip or concave guide groove which is arranged in the longitudinal direction is provided on the outer sidewall of the bracket, and the convex guide strip or concave guide groove is matched with the concave clamping groove or convex clamping strip arranged on a side edge of each cover plate.

The elastic return structure is a metal spring which has a front end connected to a front end of the bracket and a rear end connected to a front end of the slider; the front end of the spring is fixed to the front end of the bracket and is not movable, and the rear end of the spring is fixed to the front end of the slider and can move backward together with the slider and generate a rebound pulling force, thereby providing return power for the slider after movement.

The metal spring is arranged in the concave guide groove on the sidewall of the slider or in the strip-shaped groove on the outer sidewall of the bracket.

The slider structure is a shell which can be directly fastened or plugged onto the periphery of the seat slide groove. A concave guide groove for the sliding of the cover plates is provided on the outer sidewall of the shell that does not fit with the slide groove. The slider is configured as a sliding shaft that can be connected to the seat slide groove and fixed by a clamping strip, so as to form a movable connection with the clamping strip.

The two transverse ends of each cover plate can slide along the concave guide groove or convex guide strip on the sidewall of the slider into the concave cavity of the end cap. The concave guide groove or convex guide strip arranged on the sidewall of the slider can be correspondingly butted with an arc-shaped groove or arc-shaped protruding rib on the inner sidewall of the concave cavity of the end cap.

The cover plates are a plurality of sheet-shaped bodies, and the plurality of cover plates can move into the concave cavity of the end cap one after another in the longitudinal direction.

The cover plates are made of a bendable hard material, and the cover plates sliding into the concave cavity of the end cap are stacked.

The cover plates and the end cap are integrated into one component, and the cross section of each cover plate is C-shaped and matches the cross-sectional contour of the seat slide groove.

An engagement rib or catcher is provided on either the front side or the back side of the front and/or rear end of each cover plate.

At least one convex guide strip or concave guide groove which is arranged in the longitudinal direction is provided on the outer sidewall of the bracket, and the convex guide strip or concave guide groove is matched with the concave clamping groove or convex clamping strip arranged on a side edge of each cover plate.

A strip-shaped transverse protruding rib or strip-shaped transverse groove which is arranged in a transverse direction is provided on at least one of the two longitudinal sidewalls of each cover plate.

The arc-shaped groove arranged on the inner sidewall of the concave cavity of the end cap is configured as follows: arc-shaped grooves are arranged on two sides of an inner core which matches the concave cavity of the end cap, and the arc-shaped grooves are jointly formed by an outer sidewall of the inner core and an inner sidewall of the concave cavity of the end cap.

The rebound elastic force provided by the return spring for the cover plate structures is less than the elastic force generated by the elastic return structure for return of the slider after the slider moves.

### Beneficial Effects

1. Since the bracket that can be directly mounted or fastened onto a seat slide groove available on the market is provided and the cover plates are arranged at the top of the seat slide groove, by means of an end cap which is connected to a slider structure, the cover plates can make relative linear movement in a longitudinal direction when the seat moves, and the cover plates and the end cap can return by means of metal springs which serve as elastic return structures. The number of cover plates matching the top profile of the seat slide groove can be increased or decreased according to the specifications of different rail strokes. When the seat moves, the cover plates always cover the groove body of the slide groove. Only when the end of the rail inside the slide groove moves beyond the slide groove, the end cap starts to move together with the slider, and always covers the ends of the rail and the slide groove without affecting the use and safety of the seat. Thus, the device is adapted to various specifications of automobile seats currently available on the market, overcoming the defect in the references that the seat slide groove and rail structures need to be customized or modified.
2. Since the bracket clamping strip is configured as a strip-shaped body, with the inner sidewall thereof being provided with a buckle that can be fastened onto a side of the seat slide groove and is fixed to the side, and the outer sidewall thereof being provided with a strip-shaped groove or strip-shaped protruding rib which matches the strip-shaped slider, the slider can slide smoothly along the clamping strip. The bracket clamping strip may also be configured as a C-shaped buckle that can be directly fitted onto a side of the seat slide groove. The bracket clamping strip may also be configured as a clamping sleeve that can be directly fixed at the groove bottom of the seat slide groove by means of a screw originally arranged inside the automobile seat slide groove. As the strip-shaped slider matches the clamping sleeve and is embedded in the gap of the clamping sleeve, the device achieves convenient mounting and a dust-proof protection function without changing the existing structures and functions of the seat slide rail and groove, while overcoming the defects existing in the references. In addition, according to different seat specifications, the cover plates and the end cap can be configured as an integrated component, and the bracket and the slider can also be configured as an integrated component, thereby facilitating the adaptation to various specifications of automobile seats, reducing the external dimensions of the device of the present application and simplifying the structure.
3. Since the sidewall of the slider of the slider device is provided with a convex guide strip or concave guide groove arranged in the longitudinal direction, and the convex guide strip or concave guide groove is matched with the concave clamping groove or convex clamping strip arranged on the side edge of each cover plate, the cover plates can move together with the slider, preventing the cover plates from misalignment during movement, and endowing the cover plates with a certain rigidity to achieve load-bearing and durable performance. Therefore, the device of the present application avoids the defects in the references that a dust-proof strip cannot bear load and the existing seat structure needs to be modified.
4. Since the cover plates is made of a hard material with a certain rigidity that can be slightly bent, and the concave clamping groove or convex clamping strip which matches the slider is provided on the side edge of each cover plate, the cover plates can slide along the guide groove or guide strip arranged on the sidewall of the slider and move into the concave cavity of the end cap on after another. The inner sidewall of the concave cavity of the end cap is provided with an arc-shaped groove for guiding the cover plates to slide into the end cap. The cover plates sliding into the concave cavity of the end cap are stacked like sheets, and can move together with the end cap and the slider, achieving the advantages of compact structure, high rigidity and safe use. Thus, the device of the present application avoids the problem in the references that the end cap has a large size when the end of the seat rail is beyond the slide groove, which affects the foot space of the passenger seat and causes potential safety hazards. Also, the device of the present application overcomes the defect of complex structure and the jamming problem during use, as mentioned in the references. In addition, when the distance from the connection point between the seat and the rail to the end of the rail is relatively large, the cover plates and the end cap can be configured as an integrated component and the cover plate has a C-shaped cross section, thereby achieving dust-proof safety for the position from the connection point between the seat and the rail to the end of the rail, and simplifying the structure of the device of the present application.
5. Since a return spring is arranged between a cover plate and the slider or between a cover plate and the bracket structure, such that the return spring provides a rebound pulling force for the cover plate after movement occurs between the cover plate and the slider or between the cover plate and the bracket structure. The return spring can be arranged inside the slider. When the device of the present application is mounted at each of the front and rear ends of the slide groove at the bottom of the seat, the elastic return structures are arranged between the sliders at the front and rear ends of the automobile seat. The two fixed fulcrums of the spring 5 of the elastic return structure are respectively fixedly connected to the front ends of the two sliders 2, so as to provide return power for the sliders after movement, thereby simplifying the structure of the device of the present application.

### BRIEF DESCRIPTION OF THE DRAWINGS

FIG. 1 is a partial sectional structural view of a first preferred embodiment of the dust-proof device of the present application.

FIG. 2 is a partial sectional structural view of an end cap and a cover plate in the first preferred embodiment of the present application.

FIG. 3 is a partial sectional structural view showing the cover plate sliding into the end cap in the first preferred embodiment of the present application.

FIG. 4 is another partial sectional structural view of the first preferred embodiment of the present application.

FIG. 5 is a partial sectional structural view of an elastic return structure in the first preferred embodiment of the present application.

FIG. 6 is a partial sectional structural view of an elastic return structure assembly in the first preferred embodiment of the present application.

FIG. 7 is a partial sectional structural view of a first embodiment of cover plates in the present application.

FIG. 8 is a partial sectional structural view of a second embodiment of cover plates in the present application.

FIG. 9 is a partial sectional structural view of a third embodiment of cover plates in the present application.

FIG. 10 is a partial sectional structural view of a fourth embodiment of cover plates in the present application.

FIG. 11 is a partial sectional structural view of a fifth embodiment of cover plates in the present application.

FIG. 12 is a structural schematic view of a first embodiment of a C-shaped buckle in the present application.

FIG. 13 is a structural schematic view of a second embodiment of the C-shaped buckle in the present application.

FIG. 14 is a structural schematic view of a third embodiment of the C-shaped buckle in the present application.

FIG. 15 is a partial sectional structural view showing the assembly of an end cap and a slider structure in the present application.

FIG. 16 is a partial sectional structural view of a second embodiment of the dust-proof device of the present application.

FIG. 17 is an enlarged sectional structural view of part F in FIG. 16.

FIG. 18 is a partial sectional structural view of a third embodiment of the dust-proof device of the present application.

FIG. 19 is a partial sectional structural view of an assembled structure of a bracket, a slider and an end cap in the present application.

FIG. 20 is a partial sectional structural view of a fourth embodiment of the dust-proof device of the present application.

FIG. 21 is a partial sectional structural view of a second embodiment of the elastic return structure in the present application.

FIG. 22 is a partial sectional structural view of a third embodiment of the elastic return structure in the present application.

FIG. 23 is a structural schematic view of the second embodiment of the end cap in the present application.

FIG. 24 is a structural schematic view of an inner core in the second embodiment of the end cap in the present application.

FIG. 25 is another structural schematic view of the inner core in the second embodiment of the end cap in the present application.

FIG. 26 is yet another structural schematic view of the inner core in the second embodiment of the end cap in the present application.

### DETAILED DESCRIPTION OF THE INVENTION

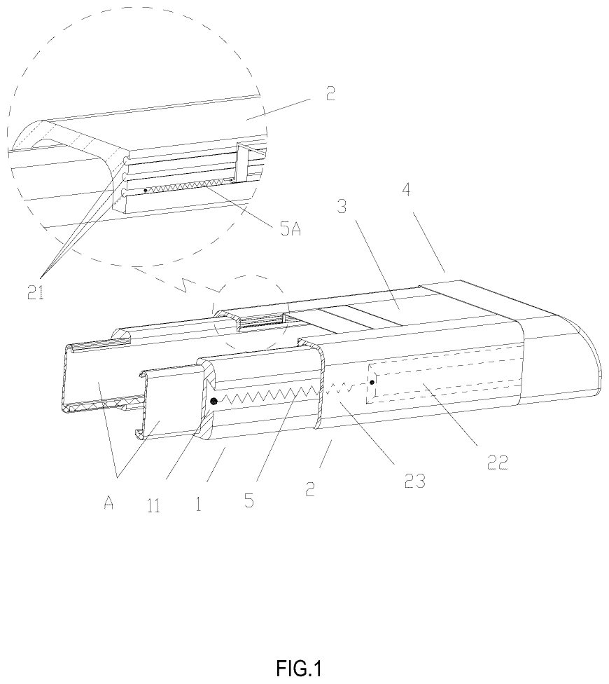

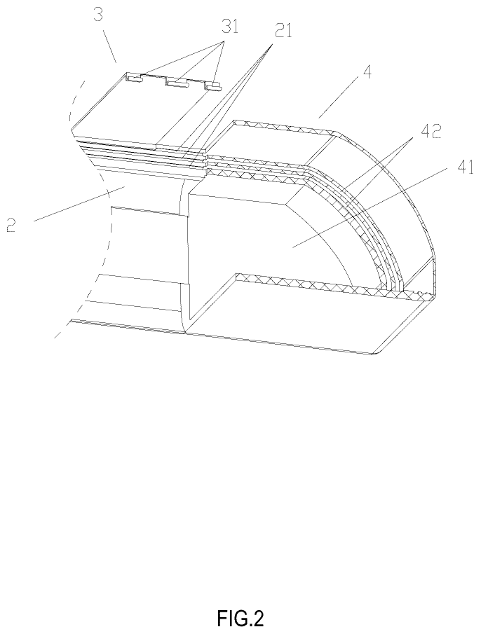

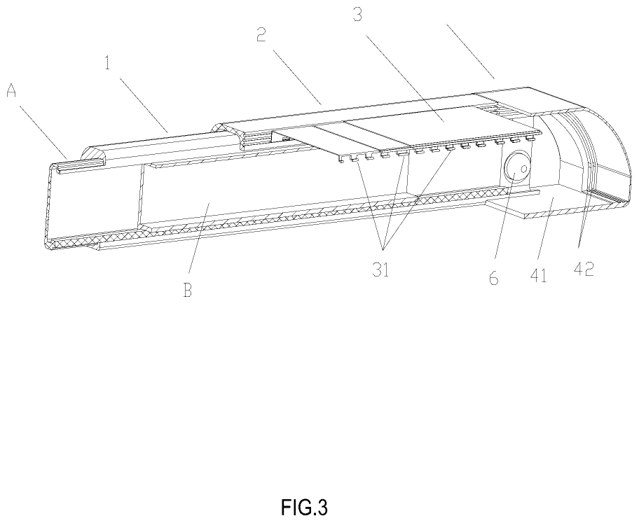

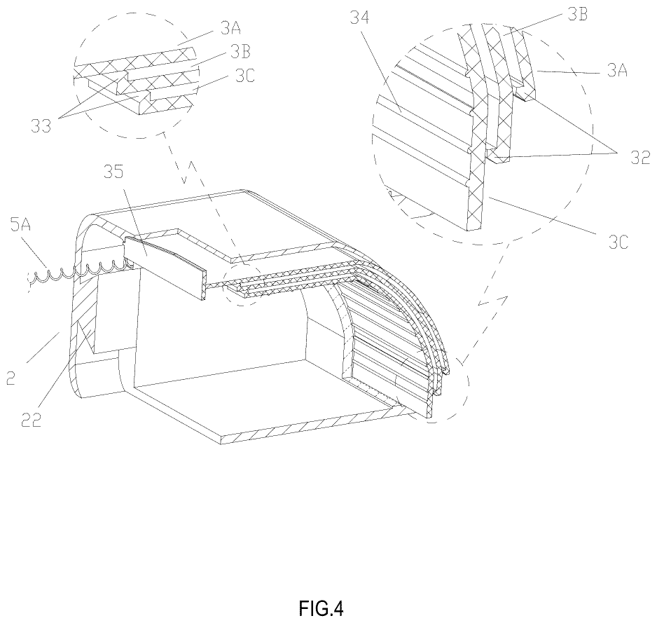

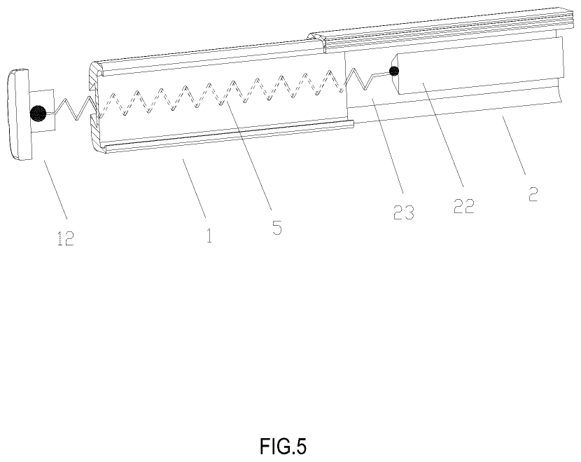

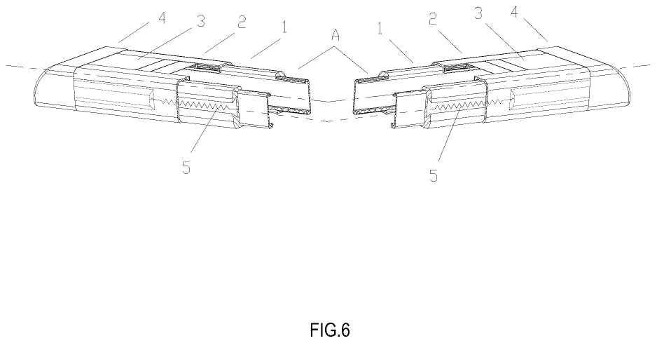

With reference to FIGS. 1 to 6, the technical solution adopted in the present application is an dust-proof device for automobile seat rails. The dust-proof device includes: at least one bracket structure connectable to a seat slide groove A. Each bracket is a clamping strip 1 fixed to a side wall of the seat slide groove A; the clamping strip 1 of the bracket structure may be a strip-shaped body, such as a strip-shaped column or sheet. A buckle that can be fastened to the side of the seat slide groove is provided at upper and/or lower edges of the inner side of the clamping strip 1 and is fixed to the side of the seat slide groove. The two clamping strips 1 of the brackets fastened to the two sides of the seat slide groove can be mutually fastened and fixed by means of transverse bayonets arranged on the bottom. A strip-shaped groove 11 or strip-shaped protruding rib that matches a strip-shaped slider 2 is provided on an outer sidewall of the clamping strip 1, so that the strip-shaped groove 11 or strip-shaped protruding rib is matched with a strip-shaped protruding rib 22 of the slider 2 and is in embedded connection with the strip-shaped protruding rib 22. After coming into embedded connection, the bracket structure and the slider structure can make relative linear movement in a longitudinal direction. By means of the strip-shaped protruding rib 22 or strip-shaped groove which is arranged on an inner side of the slider 2 and matches the clamping strip, the slider 2 and the clamping strip 1 can be mutually matched and connected and can make relative movement in the longitudinal direction, so that the slider 2 can slide smoothly along the clamping strip 1. An end cap 4 is arranged at a rear end of the slider 2; the end cap 4 has a concave cavity structure which matches an end of the seat slide groove A. The slider 2 and the end cap 4 can be fixedly connected, and the connection point thereof may be the rear end of the slider 2 fixedly connected to a sidewall of the end cap 4, so that the slider 2 and the end cap 4 can move together. To enable the slider 2 and the end cap 4 to return after movement, an elastic return structure is arranged at a front end of the slider 2, and two fixed fulcrums of the elastic return structure are fixedly connected to a relatively fixed fulcrum and a relatively movable fulcrum respectively. The elastic return structure may be a metal tension spring 5 arranged between the front end of the bracket clamping strip 1 and the front end of the slider 2; two fixed fulcrums of the spring are fixedly connected to the bracket clamping strip 1 and the slider 2 respectively. The front end of the spring 5 is connected to the front end of the bracket clamping strip 1 and the rear end of the spring 5 is connected to the front end of the slider 2. The front end of the spring 5 is fixed to the front end of the bracket clamping strip 1 and is unmovable to serve as a fixed fulcrum. The rear end of the spring 5 is fixed to the front end of the slider 2 and serve as a relatively movable fulcrum, which can move backward together with the slider 2 and generate a rebound pulling force, thereby providing return power for the slider 2 after movement. A plunger 12 which matches the front end of the slider 2 and the strip-shaped groove 11 may be arranged at the front end of the slider and is configured to connect the spring 5. No strip-shaped protruding rib is arranged at the front end 23 of the inner sidewall of the slider 2, and a space is reserved for accommodating the contracted spring 5, so that the spring 5 is not exposed. In this way, the structure is more compact, and the spring can function safely. A plurality of cover plate structures which match the top profile of the seat slide groove A are arranged at the top of the seat slide groove A. At least one transverse end of a cover plate 3 of each cover plate structure is movably connected to the sidewall of the top of the slider 2 in an embedded manner and can slide relative to the slider 2 in the longitudinal direction. When the seat moves backward, the cover plates 3 can move linearly backward in the longitudinal direction by means of the backward thrust of the seat. To enable the cover plates 3 to move forward to return its original position when the seat moves forward, a return spring 5A may be arranged between the cover plates 3 and the slider 2 or between the cover plates and the bracket structure, so as to provide rebound pulling force for the cover plates 3 after movement between the cover plates 3 and the slider 2 or between the cover plates and the bracket of the bracket structure. The return spring 5A is a tension spring arranged between the cover plates and the slider; the spring 5A may be embedded in concave guide grooves 21 arranged on the sidewall of the top of the slider 2 and configured to match convex clamping strips 31 at a transverse end of each cover plate 3. The spring 5A is connected to the first cover plate, and the other end of the spring 5A is connected to the front end of the slider 2, so as to provide rebound pulling force for the cover plate after movement. When the seat moves backward (FIG. 3), the cover plates 3 first perform linear movement in the same direction in the longitudinal direction while the end cap 4 and the slider 2 remain stationary. When the seat moves backward until the rear end of the seat rail reaches the rear end of the seat slide groove, the rear end of the rail enters the end cap, and the side of the rail B at the rear end presses a ball-head clamp pin 6 arranged at the rear ends of the bracket clamping strip 1 and the slider 2 (FIG. 3), and then the bracket clamping strip 1 and the slider 2 can disengage from the locking of the ball-head clamp pin 6 and make relative movement. Since the rear end of the slider 2 is fixedly connected to the sidewall of the end cap 4, the cover plates 3, the end cap 4 and the slider 2 move together. Only when the rear end of the rail B inside the seat slide groove moves beyond the rear end of the slide groove, does the end cap 4 start to move together with the slider 2. The cover plates sliding into the concave cavity 41 of the end cap can move together with the end cap and the slider, and the end cap always covers the end of the rail without affecting the use and safety of the seat. Alternatively, the rebound elastic force provided by the return spring 5A for the cover plate 3 structures is less than the elastic force generated by the elastic return structure for return of the slider 2 after the slider 2 moves. That is, the tension value of the spring 5A is less than that of the spring 5, thereby ensures that the slider can start moving backward only after the cover plates 3 slides into the concave cavity 41 of the end cap one after another. The movement mode of the cover plates 3 can be as follows: The first cover plate 3A moves backward and pushes the cover plates 3B and 3C to move backward together; the rear end of the cover plate 3C enters the end cap first. Since the inner sidewall of the concave cavity 41 of the end cap is provided with arc-shaped grooves 42 for guiding the cover plates to slide into the concave cavity, the concave guide grooves 21 arranged on the sidewall of the slider are respectively butted with the arc-shaped grooves 42 on the inner sidewall of the concave cavity 41 of the end cap. When the transverse ends of each cover plate 3 are configured as longitudinally open grooves, the inner sidewalls of the concave cavity 41 of the end cap may be provided with corresponding arc-shaped protruding ribs. An engagement rib 32 or catcher 33 is provided on either the front side or the back side of the front and/or rear end of each cover plate. After the cover plate 3C fully slides into the end cap, the catcher 33 at the front end of the cover plate 3C automatically disengages from the engagement rib 32 at the rear end of the cover plate 3B by virtue of the cover plate's own elasticity. Similarly, after the cover plate 3B fully slides into the end cap, the catcher 33 at the front end of the cover plate 3B automatically disengages from the engagement rib 32 at the rear end of the cover plate 3A. As the cover plates 3 are made of a bendable hard material with a certain rigidity, the cover plates slide along the concave guide grooves 21 arranged on the sidewall of the slider 2 and enter the concave cavity 41 of the end cap one after another. The cover plates 3 sliding into the concave cavity of the end cap are stacked like sheets (FIG. 4), and the positional order of the cover plates after entry can also be 3C, 3B, 3A from top to bottom. During the returning process, under the action of the return spring 5A, when the rear end 32 of the cover plate 3A slides out of the end cap, the catcher 33 at the front end of the cover plate 3B hooks onto the engagement rib 32 at the rear end of the cover plate 3A and then the cover plate 3B starts to be pulled out of the end cap by the cover plate 3A. The cover plate 3C is pulled out of the end cap in the same way. Another movement mode of the cover plates 3 entering the end cap can be as follows: The cover plate 3A moves backward but the cover plate 3B remains stationary; the rear end of the cover plate 3A enters the interior of the cover plate 3B. After the cover plate 3A fully slides into the interior of the cover plate 3B, the cover plates 3A and 3B start to enter the interior of the cover plate 3C integrally. After the cover plates 3A and 3B fully slide into the interior of the cover plate 3C, the cover plates 3A, 3B and 3C start to slide into the end cap integrally. The return sequence can be opposite to the sequence of the cover plates entering the end cap. To enable the cover plates to move sequentially in an orderly manner, a clamp pin can be arranged at the front or rear end of each cover plate, and the release of each clamp pin is controlled by the previous or subsequent cover plate. Yet another mode may be a combination of the above two modes of the cover plates entering the end cap. To enable the sheet-shaped cover plates to be bendable and have better rigidity, as well as to prevent the cover plates from slipping out of the slider, the protruding ribs at the two transverse ends of each cover plate are arranged discontinuously. To enhance the rigidity of the cover plates, transverse ribs 34 may be arranged on the bottom side of each cover plate. A clamping plate 35 may be arranged at the front end of the first cover plate to achieve better contact with connecting part B1 of a seat base during movement. The number of cover plates can be increased or decreased according to the stroke of different seat rails. When the connecting part B1 of the seat base does not exceed the rear end of the seat slide groove, the cover plates always cover the groove of the slide groove. Generally, the connecting part B1 of the seat base is flush with the end of the rail. However, since the ends of rails of some specifications of seats available on the market extend beyond the connecting part of the base, the portion from the connecting part of the base to the end of the rail can still be covered by the cover plates in this design solution when the connecting part of the seat base slides out of the end of the slide groove. The cover plates 3 are matched with the top profile of the seat slide groove A, so as to reduce the gaps between the cover plates and the seat slide groove and between the cover plates and the seat rail, achieving a perfect fit. Therefore, the device can also be adapted to various specifications of automobile seats currently available on the market, overcoming the defect in the references that the seat slide groove and rail structures need to be customized or modified. The device of the present application has the advantages of a compact structure and safe use, thereby avoiding the problem in the references that the end cap has a large size when the end of the seat rail is beyond the slide groove, which affects the foot space of the passenger seat and causes potential safety hazards. Also, the device of the present application overcomes the defect of complex structure and the jamming problem during use, as mentioned in the references. When the device of the present application is mounted on the slide grooves on both the front and rear sides of the automobile seat (FIG. 6), the elastic return structure is arranged between the sliders at the front and rear ends of the automobile seat. The two fixed fulcrums of the spring 5 of the elastic return structure are respectively fixedly connected to the front ends of the two sliders 2, so as to provide return power for the sliders after movement. The return spring for return of the cover plates is arranged between the first cover plates at the front and rear ends of the automobile seat, thereby reducing the size of the device and achieving the advantage of a compact structure.

### DETAILED DESCRIPTION OF THE INVENTION

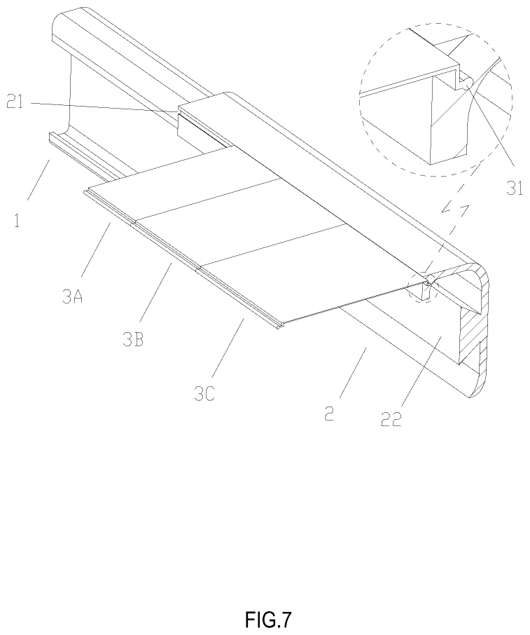

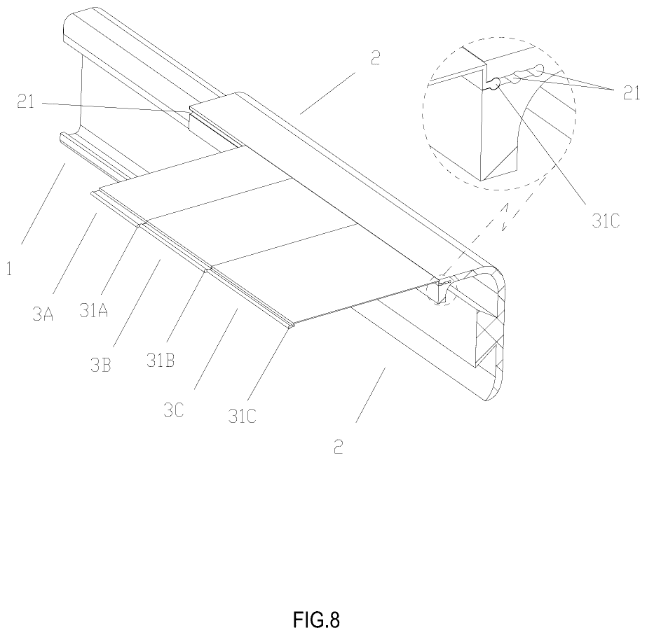

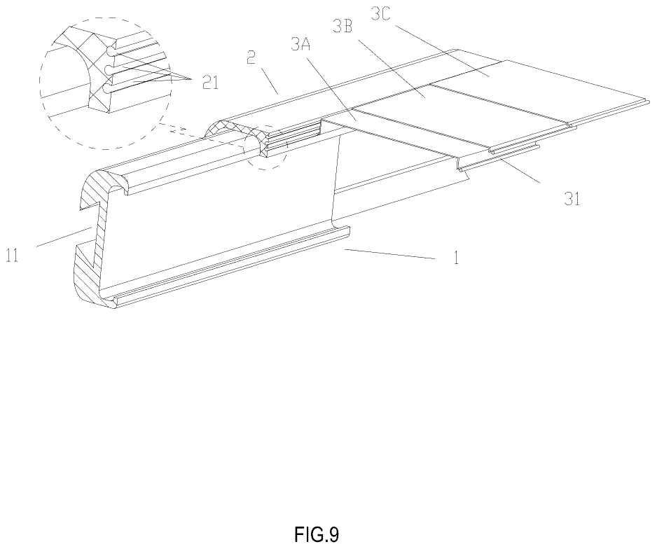

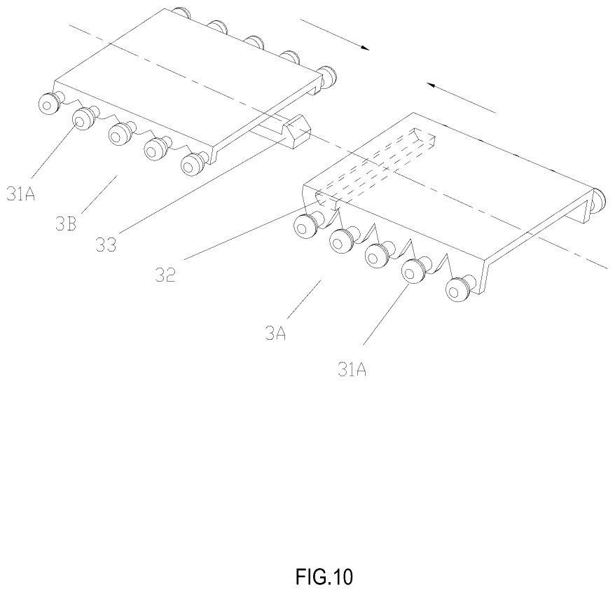

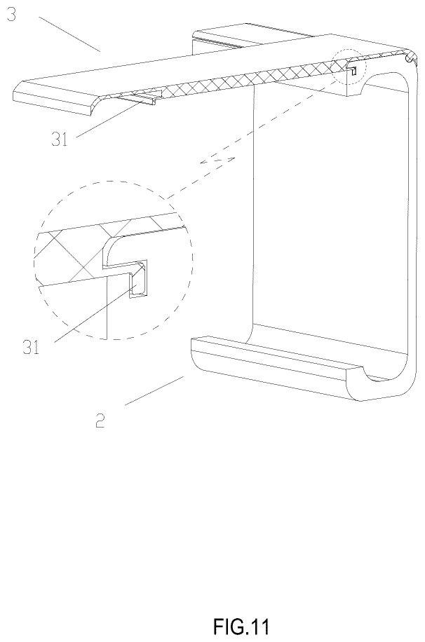

With reference to FIGS. 7 to 11, at least one strip-shaped protruding rib 22 is provided on the inner sidewall of the slider 2 of the slider device; the cross section of the strip-shaped protruding rib 22 may be trapezoidal or arc-shaped. At least one strip-shaped groove 11 matching the strip-shaped protruding rib 22 of the slider 2 may be provided on the outer sidewall of the bracket, so that the strip-shaped protruding rib 22 and the strip-shaped groove 11 are matched and fitted with each other. Conversely, the strip-shaped protruding rib of the slider may also be configured as a groove, and the groove on the outer sidewall of the bracket may also be configured as a strip-shaped protruding rib. Similarly, when a strip-shaped protruding rib is provided on the outer sidewall of the slider 2 of the slider device, a strip-shaped groove matching the protruding rib may be provided on the inner sidewall of the bracket. A plurality of strip-shaped protruding ribs and a plurality of strip-shaped grooves may be provided. A convex guide strip or concave guide groove 21 which is arranged in a longitudinal direction is provided on the side of the top of at least one outer sidewall of the slider 2 of the slider device, and the convex guide strip or concave guide groove 21 is matched with the concave clamping groove or convex clamping strip 31 arranged on the side edge of each cover plate. When the structural dimensions of the transverse ends of all cover plates are consistent (FIG. 7), the protruding ribs on the two transverse sides of the cover plates 3A, 3B and 3C are embedded in the same longitudinal concave guide groove 21 on the side of the top of the slider 2. The area between the protruding ribs at the two transverse ends of each cover plate is raised upward by a certain dimension. That is, the horizontal portion of the upper surface of the middle part of each cover plate is higher than that of the concave clamping grooves or convex clamping strips 31 at the two transverse ends. Therefore, when a cover plate is embedded in the concave guide groove 21 of the slider, the upper surface of the cover plate is flush with or higher than the upper surface of the slider. When the horizontal positions of the transverse ends of all cover plates are consistent but their transverse dimensions are inconsistent (FIG. 8), and the transverse dimensions of the protruding ribs 31A, 31B and 31C on the two transverse sides of the cover plates 3A, 3B and 3C decrease sequentially, the three concave guide grooves 21 on the side of the top of the slider, which match the protruding ribs of the cover plates, are arranged on the same horizontal plane and communicate with each other, and the protruding ribs on the two sides of the three cover plates slide in the corresponding concave guide grooves respectively. The protruding ribs on the two transverse sides of the cover plates may also be configured to have inconsistent heights (FIG. 9), in which case the corresponding longitudinal concave guide grooves 21 on the side of the top of the slider are three concave guide grooves located at different heights in the vertical direction. The protruding ribs on the two transverse sides of the cover plates may be configured as pulleys 31A facilitating bending and sliding, or as fixed ball heads (FIG. 10). An engagement rib 32 is arranged on the bottom side of the rear end of the cover plate 3A, and a catcher 33 is provided on the bottom side of the front end of the cover plate 3B, so that the two cover plates can be engaged with each other. When the two cover plates both slide in the concave guide grooves of the slider, the two cover plates are engaged with each other. When the cover plate 3A slides into the end cap, the rear end of the cover plate 3A tilts upward due to its own upward elastic force, and the engagement rib 32 of the cover plate 3A is automatically disengaged from the catcher 33 of the cover plate 3B. Given the certain rigidity of the cover plates and in order to accommodate the special condition of asymmetric slide grooves of seats available on the market, a convex clamping strip or a concave clamping groove may be provided at one of the left and right ends of the cross section of each cover plate. The cross section of the cover plates may also be configured into a “C” shape (FIG. 11) such that the upper surface of each cover plate is higher than and covers the upper surface of the slider, thereby further achieving a dust-proof effect.

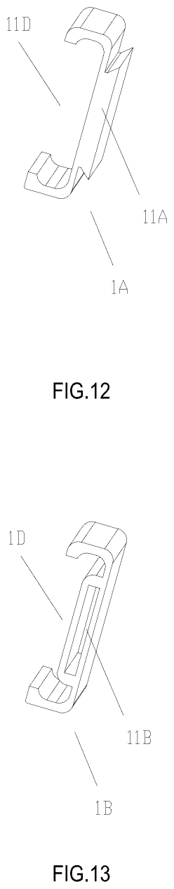

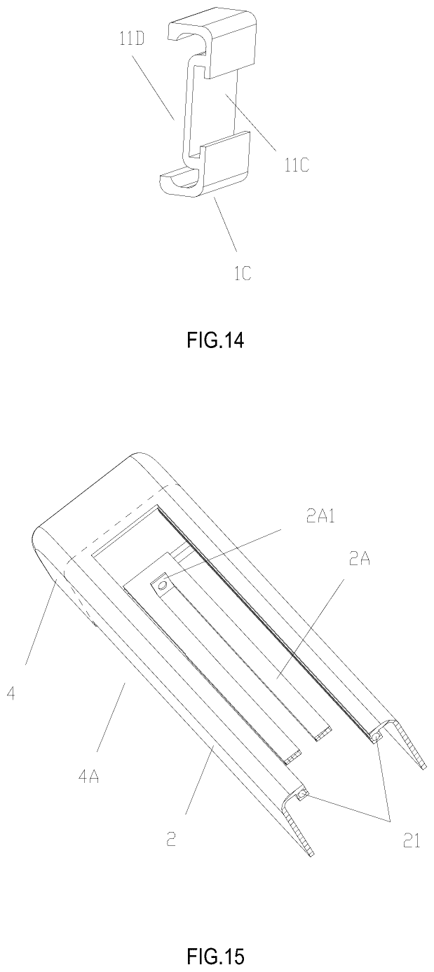

With reference to FIGS. 12 to 14, in addition to strip-shaped columns or sheet-shaped members, the bracket clamping strips may also be a plurality of C-shaped buckles that can be directly fitted on the sides of the seat slide groove. A strip-shaped groove or a strip-shaped protruding rib which matches the strip-shaped slider is provided on the outer sidewall or the inner sidewall of each C-shaped buckle. For example, one C-shaped buckle may be fitted at each of the front end and the rear end of each side of the seat slide groove. In this way, the slider is supported and costs are saved. The C-shaped buckle is structured such that one side is a C-shaped clip 11D fitted on a side of the seat slide groove, and the other side is a raised block 11A which matches the slider (FIG. 12). The C-shaped buckle may also be structured such that one side is the C-shaped clip 11D fitted on a side of the seat slide groove, and a cavity 11B matching the strip-shaped slider is provided between the C-shaped clip 11D and the other sidewall (FIG. 13). The C-shaped buckle may also be structured such that one side is a C-shaped clip 11D fitted on a side of the seat slide groove and the other side is a groove 11C which matches the slider on the other side (FIG. 14). The bracket structure may also be directly fitted or attached to an outer sidewall of the seat slide groove by means of screws or magnetically.

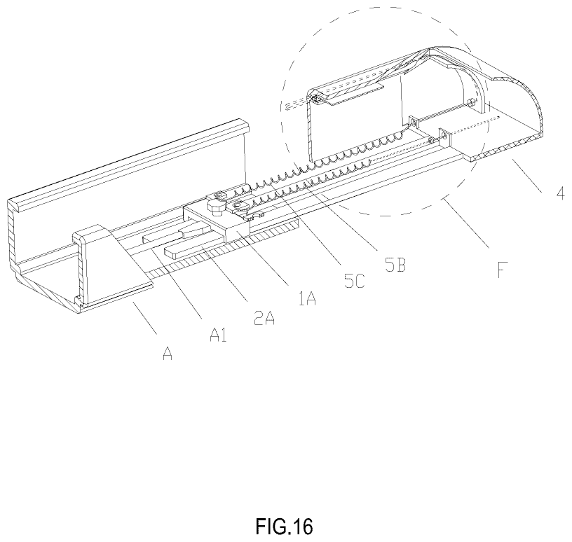

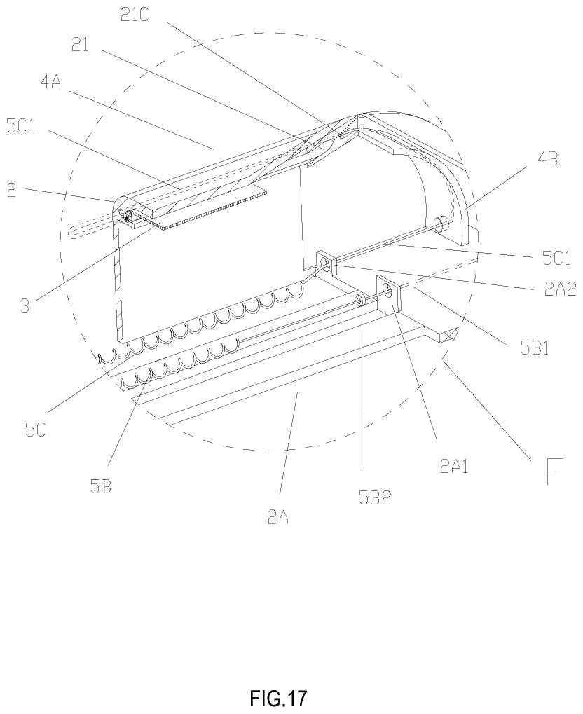

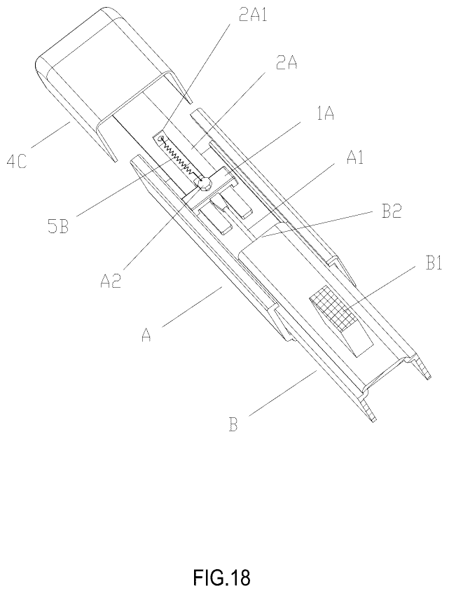

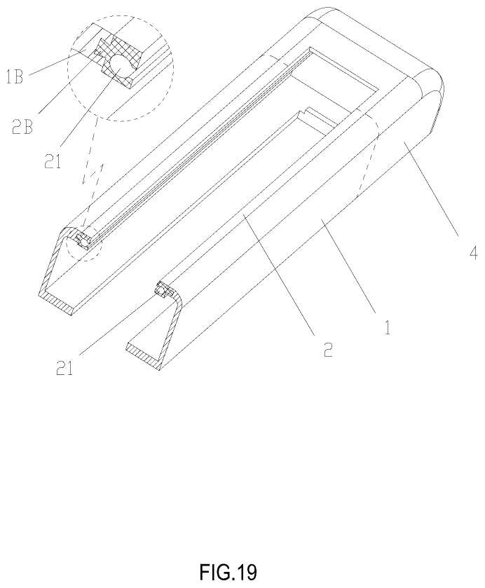

With reference to FIGS. 15 to 19, the slider and end cap described in the present application may be arranged and combined according to specifications of different seats. When the end cap and the slider are configured as an integrated component, the slider structure is a shell structure 4A formed by combining the end cap and the slider, and the shell structure 4A can be directly fastened or plugged onto the periphery of the seat slide groove (FIG. 15). The shell is matched with the seat slide groove in shape, and the shell 4A and the end cap 4 are configured as an integrated component. The two ends of the end cap 4 shell are connected to the rear end face of the slider, and at least one sliding shaft 2A is arranged at the bottom surface of the end cap shell. A support column 2A1 for connecting an elastic return structure may be arranged at the rear end of the sliding shaft 2A. A concave guide groove 21 for the sliding of the cover plates is arranged on a side of the top of at least one sidewall of the slider 2. The sliding shaft 2A of the slider structure is a strip-shaped sheet. The sliding shaft may also be composed of two shafts arranged in parallel and spaced apart. The cross section of the sliding shaft may be a rectangular sheet structure, or a “T”-shaped or “L”-shaped structure. The clamping strip of the bracket structure is a clamping sleeve 1A which can be fixed to the groove bottom of the seat slide groove by means of a screw A2, and the clamping sleeve 1A is matched with the strip-shaped sliding shaft 2A. The strip-shaped sliding shaft 2A is embedded in the gap of the clamping sleeve and can move linearly along the groove bottom of the seat slide groove in the longitudinal direction in the gap of the clamping sleeve. A hanging hole for connecting the elastic return structure may be arranged on the clamping sleeve 1A, and the elastic return structure may be arranged between the bracket and the end cap. That is, one end of the spring 5B of the elastic return structure is fixedly arranged on the clamping sleeve 1A or connected and fixed to the screw A2, and the other end of the spring 5B is connected to the support column 2A1 at the rear end of the strip-shaped sliding shaft 2A. When the slider and the end cap are integrated into one component and combined into a shell structure 4A and the clamping strip of the bracket structure can be fixed to the groove bottom of the seat slide groove by means of the screw A2, in this embodiment, the fixed ends of the tension spring and the return spring of the elastic return structure both can be arranged between the clamping sleeve 1A and the end cap 4. A corner fulcrum 2A2 is arranged in the end cap or at the rear end of the sliding shaft 2A of the slider structure, the rear end of the return spring 5C is extended to the front end of the first cover plate 3 by means of a pull wire 5C1 and connected and fixed to the cover plate, so as to provide a rebound pulling force for the cover plate after movement. In this embodiment, the tension spring 5B and the return spring 5C of the elastic return structure may be combined into a single tension spring, the tension spring 5B is used for providing the return power after the combination. The pull wire 5C1 of the return spring 5C is combined with the pull wire 5B1, and the pull wire is extended to the front end of the first cover plate to provide a rebound pulling force for the cover plate 3 after movement. An adjustable-position limiting block 5B2 is arranged between the clamping sleeve 1A and the support column 2A1. When the cover plates 3 moves into the end cap and pulls the spring 5B by means of the pull wire 5C1, the spring 5B is stretched; and when the cover plates stop moving into the concave cavity of the end cap, the limiting block 5B2 abuts against the support column 2A1, and then the end cap and the slider start to move backward. In order to enable the pull wire 5c1 extending to the front end of the first cover plate to perform its function more smoothly, a support block 4B may be arranged at a stress corner in the end cap, and support shafts may also be arranged at other corners. A longitudinal through hole 21C for accommodating the pull wire 5C1 is arranged in the sidewall of the slider shell, so as to guide the pull wire 5C1 to the front end of the cover plate 3. This embodiment has the advantages of cost saving, compact structure and safe use. The arrangement of this structure can avoid affecting an electric adjustment accessory A1 which is originally arranged in the seat slide groove and the sliding function of the seat rail B. The slider, the end cap and the cover plates may also be configured as a shell structure 4C with a brim (FIG. 18), which may be directly fastened onto the seat slide groove A for use. Since there is a certain distance from part B1 of the seat, which is connected to the bottom rail B, to the rear end B2 of the rail, the length of the brim matches the distance from the connection part B1 to the rear end B2 of the rail in this solution, thereby achieving a better dust-proof and protective effect. To adapt to different automobile seat rails and slide grooves (FIG. 19), the bracket structure is configured as a shell that can be directly fastened onto the seat slide groove for use. At least one longitudinal concave guide groove which matches the convex guide strip 2B of the slider 2 is arranged on the outer sidewall 1B of the bracket structure, such that the slider 2 and the bracket structure can move relative to each other in the longitudinal direction. The concave guide grooves 21 arranged on the sidewalls of the slider 2 are matched with the convex clamping strip arranged on the side edge of each cover plate, and the slider 2 and the end cap 4 may be integrated into one component. When the stroke of the seat rail is short or the seat slide groove is long, if no relative longitudinal movement is required between the slider and the bracket, and only relative longitudinal movement is needed between the cover plates and the bracket structure as well as the slider, the slider and the bracket may be integrated into one component, and the concave guide groove 21 which matches the cover plates may also be arranged on the side of each bracket clamping strip 1. Alternatively, the outer side of the integrated shell formed by combining the slider and the bracket may be configured as a structure matching the cover plates in shape to facilitate the movement of the cover plates, thereby reducing the external dimensions of the present application. In addition, when the bracket, end cap and slider are combined into a shell structure that can be directly fastened or plugged onto the periphery of the seat slide groove, the shell is matched with the seat slide groove in shape. At least one longitudinal convex guide strip or concave guide groove may be arranged on the outer sidewall of the bracket. The convex guide strip or concave guide groove is matched with the concave clamping groove or convex clamping strip arranged on the side edge of each cover plate. In the present application, the cover plates and the end cap may be integrated into one component, and the cover plates, each having a C-shaped cross section, are fastened onto the top of the seat slide groove. This design not only solves the problems of dust prevention and safety, but also simplifies the structure of the device.

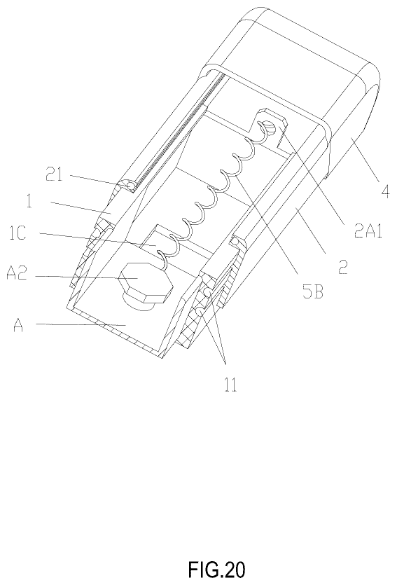

With reference to FIG. 20, the bracket structure may be a shell that can be plugged from the end of the seat slide groove, thereby enhancing the structural stability. When the end cap 4 is fixedly connected to the rear end of the slider 2, the spring 5B of the elastic return structure may also be arranged between the front end of the bracket and the rear end of the slider. That is, one of the two fixed fulcrums of the spring of the elastic return structure is fixedly connected to the fixing screw A2 at the bottom of the seat slide groove A between the front end of the bracket and the rear end of the slider to serve as a fixed fulcrum, and the other one may be fixedly connected to the end face of the end cap or the support column 2A1 at the end of the slider to serve as a movable fulcrum, so as to provide return power for the slider 2 after movement. The point of the spring connected to the seat slide groove is a fixed point, and the point of the spring connected to the end cap or the slider is a movable point that can move together with the end cap or the slider.

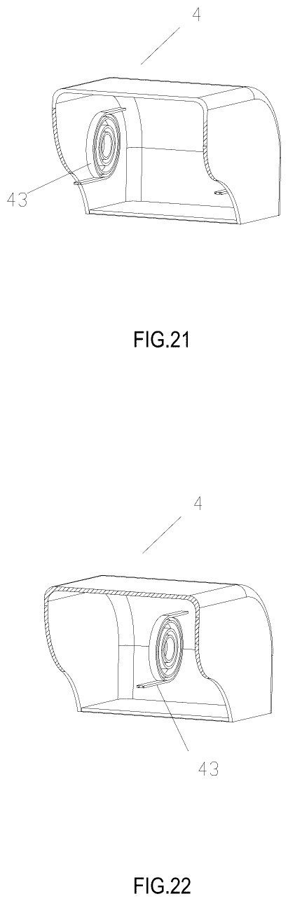

With reference to FIGS. 21 to 22, in the present application, the elastic devices that provide return power for the cover plates or the slider may each be selectively configured as a spiral spring according to the structures of the automobile seat slide groove and rail. A spiral spring 43 with a relatively small transverse dimension is arranged on each of the left and right sidewalls of the end cap (FIG. 20), or the spiral spring 43 is arranged in the middle of the concave cavity of the end cap (FIG. 21), so as to avoid hindering the operation of the seat rail. The return spring may also be an elastic device composed of a spiral spring and a gear, which are arranged in the bracket outside the seat slide groove, and a rack matched with the gear is arranged on the side edge of the slider. In addition, the spiral springs may also be compression springs. The compression spring arranged in the end cap has one end connected to the end cap and the other end connected to a cover plate to provide a forward thrust to the cover plate and also provide return power for the cover plate after movement. The elastic devices in the present application may also be flexible and elastic materials, such as rubber bands, and elastic fibers. In addition, in the present application, at least one of the two longitudinal sidewalls of each cover plate is provided with a strip-shaped transverse protruding rib or strip-shaped transverse groove arranged in the transverse direction. The contact end faces of two adjacent cover plates may be respectively provided with a transverse rib and a transverse groove, which are matched and embedded with each other, so that the combined cover plates have better rigidity and dust-proof effect.

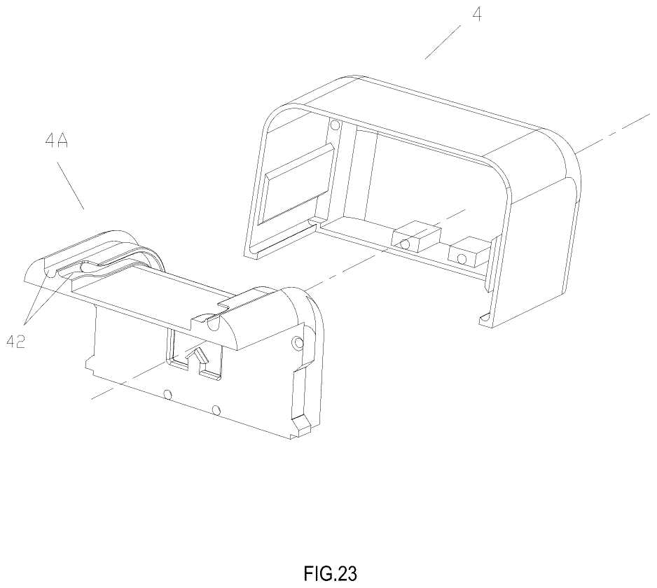

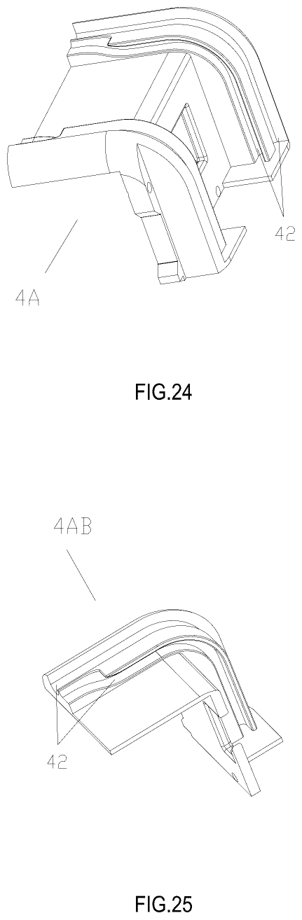

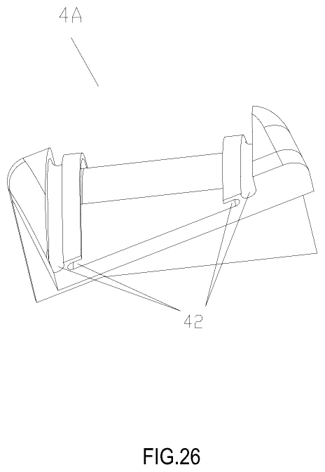

With reference to FIGS. 23 to 26, in the present application, an arc-shaped groove 42 arranged on the inner sidewall of the concave cavity 41 of the end cap 4 to guide the cover plates to slide into the concave cavity may be configured as follows: arc-shaped grooves 42 are arranged on two sides of an inner core 4A which matches the concave cavity 41 of the end cap 4, and the arc-shaped grooves 42 may be jointly formed by the outer sidewall of the inner core and the inner sidewall of the concave cavity 41 of the end cap 4. To simplify the manufacturing process, the inner core 4A may be composed of two half inner cores 4AB. Since the cross section of some automobile seat rails is asymmetrical from left to right, the end cap 4 and the inner core 4A matched with the concave cavity 41 may be asymmetrical from left to right.

### Industrial Applicability

To sum up, the structural design of the present application effectively overcomes the defects existing in the references, and achieves the advantages of low cost, simple structure, convenient mounting, high versatility, long service life and compact structure. The embodiments cited above are only for the convenience of illustrating the present application. Without departing from the scope of the creative spirit of the present application, various simple variations and modifications made by those skilled in the art shall still fall within the scope of the technical solutions of the present application.

What is claimed is:

1. A dust-proof device for automobile seat rails, wherein the dust-proof device comprises: at least one bracket structure connectable to a seat slide groove, at least one elastic return structure, an end cap, at least one slider structure connected to the end cap, and a plurality of cover plate structures which match the top profile of the seat slide groove, wherein the bracket structure at least comprises a clamping strip fixable to a sidewall of the seat slide groove; the slider structure at least comprises a slider, and at least one transverse end of a cover plate of each cover plate structure is movably connected to a sidewall of the slider structure in an embedded manner, and can slide relative to the slider structure in a longitudinal direction; the clamping strip of the bracket structure is in embedded connection with a slider of the slider structure, and can make relative linear movement in the longitudinal direction; a rear end of the slider is fixedly connected to a sidewall of the end cap; the slider returns by means of the elastic return structure after movement; two fixed fulcrums of the elastic return structure are respectively fixedly connected to one relatively fixed fulcrum and one relatively movable fulcrum; and the end cap has a concave cavity structure which matches an end of the seat slide groove.

2. The dust-proof device for automobile seat rails according to claim 1, wherein at least one longitudinally arc-shaped groove for guiding the cover plates to slide in is arranged on a sidewall of the concave cavity of the end cap.

3. The dust-proof device for automobile seat rails according to claim 1, wherein the clamping strip is a strip-shaped body, a buckle that can be fastened to a side of the seat slide groove is provided at upper and/or lower edges of the inner side of the clamping strip and is fixed to the side of the seat slide groove, and a strip-shaped groove or strip-shaped protruding rib that matches the strip-shaped slider is provided on an outer sidewall of the strip-shaped body.

4. The dust-proof device for automobile seat rails according to claim 1, wherein the clamping strip is configured as a plurality of C-shaped buckles that can be directly fitted on a side of the seat slide groove; a strip-shaped groove or strip-shaped protruding rib which matches the strip-shaped slider is provided on an outer or inner sidewall of each C-shaped buckle.

5. The dust-proof device for automobile seat rails according to claim 1, wherein the clamping strip is a clamping sleeve which can be fixed to the groove bottom of the seat slide groove by means of a screw and is matched with the strip-shaped slider; the strip-shaped slider is embedded in a gap of the clamping sleeve and moves linearly along the groove bottom of the seat slide groove in the longitudinal direction in the gap of the clamping sleeve.

6. The dust-proof device for automobile seat rails according to claim 1, wherein the slider is a strip-shaped column; a strip-shaped groove or strip-shaped protruding rib which matches the strip-shaped protruding rib or strip-shaped groove on a sidewall of the bracket is provided on an inner or outer sidewall of the slider.

7. The dust-proof device for automobile seat rails according to claim 1, wherein a convex guide strip or concave guide groove which is arranged in the longitudinal direction is provided on at least one outer sidewall of the slider, and the convex guide strip or concave guide groove is matched with a concave clamping groove or convex clamping strip arranged on a side edge of each cover plate.

8. The dust-proof device for automobile seat rails according to claim 1, wherein the cover plates are sheet-shaped; at least one convex clamping strip or concave clamping groove which is arranged in the longitudinal direction is provided at least one of two ends of the cross section of each cover plate, and the convex clamping strip or concave clamping groove is matched with a concave guide groove or convex guide strip arranged on the sidewall of the slider of the slider device.

9. The dust-proof device for automobile seat rails according to claim 1, wherein each cover plate structure further includes at least one return spring, which is arranged between the cover plate and the slider or between the cover plate and the bracket structure; the spring arranged between the cover plate and the slider or between the cover plate and the bracket structure provides a rebound pulling force for the cover plate after movement.

10. The dust-proof device for automobile seat rails according to claim 1, wherein the elastic return structure is arranged between an end of the bracket and an end of the slider, and two fixed fulcrums of the elastic return structure are respectively fixedly connected to the bracket and the slider, so as to provide return power for the slider after movement.

11. The dust-proof device for automobile seat rails according to claim 1, wherein the elastic return structure is arranged between sliders at the front and rear ends of an automobile seat, and two fixed fulcrums of the elastic return structure are respectively fixedly connected to front ends of the two sliders so as to provide return power for the sliders after movement.

12. The dust-proof device for automobile seat rails according to claim 1, wherein the cover plates and the end cap are integrated into one component.

13. The dust-proof device for automobile seat rails according to claim 1, wherein the bracket and the slider are integrated into one component.

14. The dust-proof device for automobile seat rails according to claim 1, wherein the slider structure and the end cap are integrated into one shell structure, and two end faces of an end cap shell are connected to a rear end face of the slider of the slider structure; at least one sliding shaft is arranged at a bottom side end face of the end cap shell; the sliding shaft is a strip-shaped sheet, and the cross section of the sliding shaft is rectangular, “T”-shaped or “L”-shaped.

15. The dust-proof device for automobile seat rails according to claim 1, wherein the cover plates are made of a bendable hard material, and the cover plates sliding into the concave cavity of the end cap are stacked.
